(19) United States
(12) Patent Application Publication
(10) Pub. No.: US 2007/0121563 A1
(43) Pub. Date: May 31, 2007

(54) Method and apparatus to determine wireless network link

(75) Inventor: Sung-joon Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/583,799

(22) Filed: Oct. 20, 2006

(30) Foreign Application Priority Data
Oct. 28, 2005 (KR) 2005-102501

(51) Int. Cl. H04Q 7/24

(52) U.S. Cl. 370/338

(57) ABSTRACT

A method and apparatus to determine a wireless network link includes detecting one or more connectable wireless networks, forming a link to one of the detected wireless networks, determining whether predetermined data is received via the linked wireless network, and determining the linked wireless network as a host-connected network when the predetermined data is received via the linked wireless network. The method is performed by a peripheral and the predetermined data is transmitted by a host via the host-connected network.

### CROSS-REFERENCE TO RELATED APPLICATIONS

This application claims the priority of Korean Patent Application No. 10-2005-102501, filed on Oct. 28, 2005, in the Korean Intellectual Property Office, the disclosure of which is incorporated herein in its entirety by reference.

### BACKGROUND OF THE INVENTION

1. Field of the Invention

The present general inventive concept relates to a method and apparatus to determine and/or form a wireless network, and more particularly, to a method and apparatus to determine and/or form a wireless network link, in which a peripheral supporting wireless networking detects one or more connectable wireless networks, connects itself to each of the detected wireless networks via wireless to determine whether data from a host is received via any of the connected wireless networks, and detects a wireless network to which the host is connected based on the determination result.

2. Description of the Related Art

A peripheral is a device that operates under control of a host, and is connected to the host via wire or wireless. To connect the peripheral and the host via wireless, the host or the peripheral must support wireless networking.

That the host and the peripheral are connected via wireless represents that they are connected to the same wireless network. Since there may be more than one wireless network to which the host or the peripheral can be connected, the wireless network to which the host is connected must be the same as that to which the peripheral is connected to establish a wireless connection therebetween.

For the wireless connection between the host and the peripheral, a user has to handle the setting of the host or the peripheral so that the host and the peripheral are connected to the same wireless network. Therefore, conventionally, user inconvenience is unavoidable in establishing the wireless connection between the host and the peripheral. This problem becomes more serious when the user does not know how to change the setting of the host or the peripheral.

### SUMMARY OF THE INVENTION

The present general inventive concept provides a method of determining a wireless network link, in which settings of a peripheral is not needed to establish a wireless link with a host. In the method, the peripheral supporting wireless networking detects one or more connectable wireless networks, connects itself to each of the detected wireless networks via wireless to check whether data from a host can be received via any of the connected wireless networks, and detects a wireless network to which the host is connected from the detected wireless networks based on the checking result.

The present general inventive concept also provides an apparatus to determine a wireless network link, in which a peripheral supporting wireless networking detects one or more connectable wireless networks, connects itself to each of the detected wireless networks via wireless to check whether data from a host can be received via any of the connected wireless networks, and detects a wireless network to which the host is connected from the detected wireless networks based on the checking result.

The present general inventive concept also provides a computer readable medium that stores a computer program in which a peripheral supporting wireless networking detects one or more connectable wireless networks, connects itself to each of the detected wireless networks via wireless to check whether data from a host can be received via any of the connected wireless networks, and detects a wireless network to which the host is connected from the detected wireless networks based on the checking result.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of determining a wireless network link, the method including detecting one or more connectable wireless networks, forming a link to one of the detected wireless networks, determining whether predetermined data is received via the linked wireless network, and determining the linked wireless network as a host-connected network when the predetermined data is received via the linked wireless network.

The method is performed by a peripheral, and the predetermined data is transmitted from a host via the host-connected network.

The method may further include forming a second link to the other one of the detected wireless networks and performing the determining of whether the predetermined data is received via the secondly linked wireless network when it is determined that the predetermined data is not received via the secondly linked wireless network.

The foregoing and/or other aspects and utilities of the present general inventive concept may also be achieved by providing a system to determine a wireless network link, the apparatus including a host to transmit predetermined data via a predetermined wireless network; and a peripheral to detect one or more wireless networks to which a link is to be formed with the peripheral, to form a link to each of the detected wireless networks to determine whether the predetermined data is received via the linked wireless network, and to determine the linked wireless network as the predetermined wireless network when it is determined that the predetermined data is received via the linked wireless network.

The foregoing and/or other aspects and utilities of the present general inventive concept may also be achieved by providing an apparatus to determine a wireless network link, the apparatus including a peripheral to detect one or more wireless networks, to form a link to make a link with one of the detected wireless networks to determine whether the predetermined data is received via the linked wireless network, and to determine the linked wireless network as a predetermined wireless network when it is determined that the predetermined data is received via the linked wireless network.

The foregoing and/or other aspects and utilities of the present general inventive concept may also be achieved by providing a computer readable recording medium having embodied thereon a program which executes a method of determining a wireless network link, the method detecting one or more connectable wireless networks, forming a link to one of the detected wireless networks, determining whether predetermined data is received via the linked wireless network, and determining the linked wireless network as a host-connected network when the predetermined data is received via the linked wireless network. The method is performed by a peripheral, and the predetermined data is transmitted from a host via the host-connected network.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a reference diagram illustrating a method of determining a wireless network link according to an embodiment of the present general inventive concept;

FIG. 2 is a block diagram of a system to determine a wireless network link according to an embodiment of the present general inventive concept;

FIG. 3 is a flowchart illustrating a method of determining a wireless network link according to an embodiment of the present general inventive concept; and

FIG. 4 is a view illustrating an image forming apparatus to determine a wireless network with an external host according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

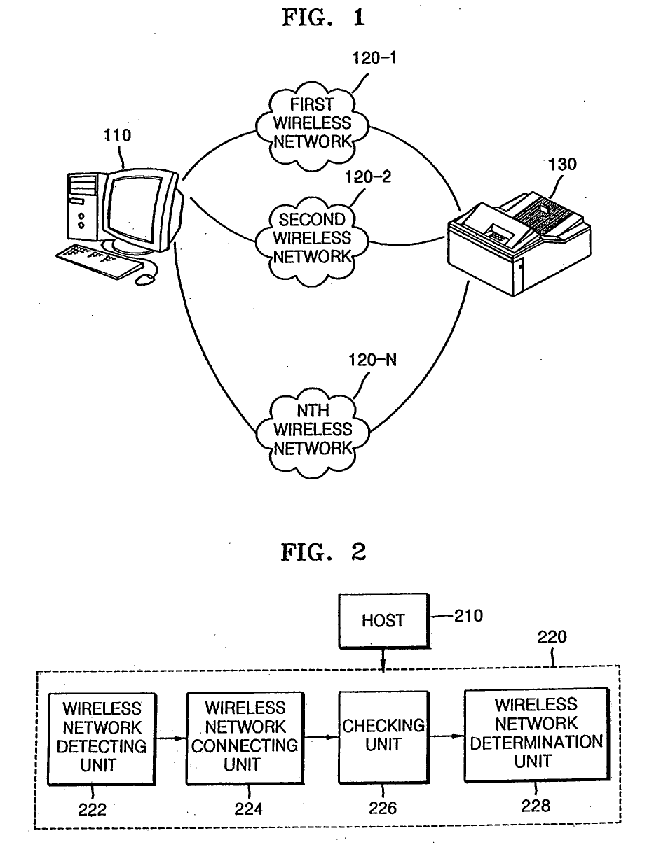

FIG. 1 is a reference diagram illustrating a method of determining a wireless network link according to an embodiment of the present general inventive concept. Referring to FIG. 1, a host 110 is connected to a peripheral 130 via wireless through a first wireless network 120-1, a second wireless network 120-2, . . . , or an n^{th} wireless network 120-N.

The peripheral 130 indicates a device that operates under control of the host 110. A personal computer (PC) is an example of the host 110, and an image forming apparatus, such as a printer, a scanner, and a multi-functional peripheral (MFP), is an example of the peripheral 130. The image forming apparatus may include a wireless interface unit to wirelessly communicate with the PC to receive data, a printing unit to print an image, and a controller to control the wireless interface unit and the printing unit to print the image according to the received data from the PC through the wireless interface unit. The wireless interface unit of the image forming apparatus may receive and/or detect one or more signals corresponding to one or more wireless networks and communicates with a second wireless interface unit of the PC to form the wireless network link through, for example, at least one of the received and/or detected one or more signals.

Although FIG. 1 illustrates N number of wireless networks, such as the first wireless network 120-1, the second wireless network 120-2, . . . , and the n^{th} wireless network 120-N (N is an integer equal to or greater than 3), the number of wireless networks is not limited. That is, more than one wireless network can be used in the present embodiment.

The wireless network 120-1, 120-2, . . . , or 120-N may have an ad-hoc structure or an infrastructure. An ad-hoc structure wireless network does not require an access point (AP), but an infrastructure wireless network requires the AP.

Each of the wireless networks 120-1, 120-2, . . . , and 120-N has a service set identifier (SSID) that identifies it from the other wireless networks. The SSID may be attached to a header of one or more packets which are transmitted between wireless interface units of the host 110 and the peripheral 130 through a predetermined wireless network. The host 110 and the peripheral 130 may exchange data through the predetermined wireless network using the SSID.

Referring to FIG. 1, both the host 110 and the peripheral 130 may be connected to one of the N wireless networks 120-1, 120-2, . . . , and 120-N.

When the host 110 and the peripheral 130 are connected via wireless, a wireless network including the host 110 and the peripheral 130 is formed. To establish the wireless network, the wireless network to which the host 110 is connected must be the same wireless network to which the peripheral 130 is connected. The host 110 and the peripheral 130 may determine a wireless network as the same wireless network according to the SSID.

For instance, when the host 110 is connected to the second wireless network 120-2, the peripheral 130 must also be connected to the second wireless network 120-2 in order to establish the wireless network that includes the host 110 and the peripheral 130. Since the peripheral 130 does not know which one of the N wireless networks 120-1, 120-2, . . . , and 120-N is connected to the host 110, the peripheral 130 is required to determine whether the one of the N wireless networks 120-1, 120-2, . . . , and 120-N is connected to the host 110 by checking a packet transmitted from the host 110 through the determined wireless network 120-1, 120-2, . . . , or 120-N.

Hereinafter, establishing the wireless network will be referred to as ‘wireless networking. Also, for convenience, a wireless network to which the host 110 is connected will be referred to as a ‘host-connected network’.

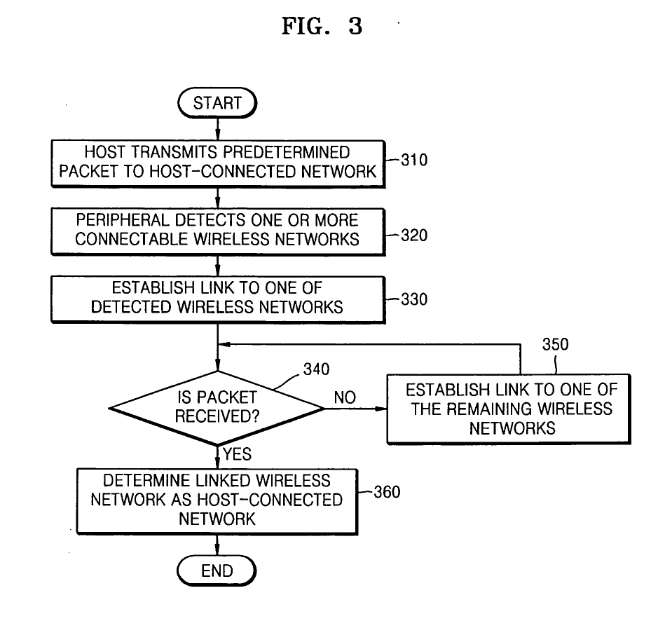

The present embodiment discloses a wireless networking technology that allows the peripheral 130 to automatically detect a host-connected network from the N wireless networks 120-1, 120-2, . . . , and 120-N without a user's operation. For instance, assuming that the host 110 is connected to the first wireless network 120-1 and the peripheral 130 is connected to the second wireless network 120-2, in order to establish the wireless network that includes the host 110 and the peripheral 130, the user need not individually change setting of the host 110 (or the peripheral 130) to change information regarding the wireless network to which the host 110 (or the peripheral 130) is connected. In this case, according to the present embodiment, the first wireless network 120-1 to be connected is automatically detected by the peripheral 130. The wireless networking technology according to the present embodiment will now be described in greater detail with reference to FIGS. 2 and 3.

FIG. 2 is a block diagram illustrating a system to determine a wireless network link according to an embodiment of the present general inventive concept. Referring to FIG. 2, the system includes a host 210 and a peripheral 220. The peripheral 220 includes a wireless network detecting unit 222, a wireless network connecting unit 224, a checking unit 226, and a wireless network determination unit 228.

The host 210 and the peripheral 220 of FIG. 2 respectively correspond to the host 110 and the peripheral 130 of FIG. 1. That is, the host 210 transmits predetermined data via a host-connected network. Here, the predetermined data may be in the form a packet. The predetermined data may include the SSID in the packet, and the SSID may be used to identify the peripheral 130 or the host 110. Hereinafter, the predetermined data will now be referred to as “a search packet.

The host 210 may transmit the search packet for a first period of time. The first period of time is predetermined but can be changed.

The search packet may be data that the peripheral 220 can recognize. Thus, the peripheral 220 detects one or more wireless networks to which it can be connected, connects itself to each of the detected wireless networks to determine whether the search packet is received via any of the connected wireless networks, and detects the host-connected network from the detected wireless networks based on the determination result.

The above-described operation of the peripheral 220 will now be described in more detail. The wireless network detecting unit 222 may have a wireless interface unit to detect one or more wireless networks connected thereto. The detection result may be in a form of a list which includes the detected wireless networks. The wireless network connecting unit 224 selects one of the detected wireless networks, and connects itself to the selected wireless network. The expression “connect itself to the selected wireless network” may be referred to as an expression “establish a link to a wireless network”.

The checking unit 226 checks whether the search packet is received via the connected wireless network for a second period of time. The second period of time is predetermined but can be changed. The second period of time may be included in the first period of time.

Next, the wireless network determination unit 228 determines the connected wireless network as the host-connected network, based on the checking result received from checking unit 226.

In detail, when the checking unit 226 determines that the search packet is received via the connected wireless network, the wireless network determination unit 228 determines the connected wireless network as the host-connected network.

However, when the checking unit 226 determines that the search packet is not received via the connected wireless network, the wireless network connecting unit 224 disconnects the peripheral 220 from the connected wireless network and connects the peripheral 220 to the other one of the wireless networks.

Then, the checking unit 226 checks whether the search packet is received via the newly connected wireless network, and the wireless network determination unit 228 determines the newly connected wireless network as the host-connected network when it is determined that the search packet is received via the newly connected wireless network.

FIG. 3 is a flowchart illustrating a method of determining a wireless network link according to an embodiment of the present general inventive concept. Referring to FIG. 3, the method includes operations 310 through 360, in which a peripheral supporting wireless networking detects one or more wireless networks to which it can be connected, connects itself to each of the detected wireless networks via wireless to determine whether data from a host is received via any of the connected wireless networks, and detects a host-connected network from the detected wireless networks, based on the determination result.

Referring to FIGS. 2 and 3, the host 210 transmits a search packet via a host-connected network in operation 310. The peripheral 220 may be connected to the host-connected network. That is, there may one or more wireless networks including the host-connected network to which the peripheral 220 can be connected.

The wireless network detecting unit 222 of the peripheral 220 detects the one or more wireless networks to which the peripheral 220 can be connected in operation 320. The wireless network connecting unit 224 of the peripheral 220 forms a link to one of the detected wireless networks in operation 330. That is, the wireless network connecting unit 224 connects the peripheral 220 to one of the detected wireless networks.

Operations 320 or 330 may be performed prior to operation 310, but operation 310 may be performed prior to the following operation 340.

The checking unit 226 of the peripheral 220 determines whether the search packet is received via the wireless network connected in operation 330 in operation 340.

When it is determined in operation 340 that the search packet is not received via the connected wireless network, the wireless network connecting unit 224 of the peripheral 220 disconnects the peripheral 220 from the wireless network connected in operation 330 and connects the peripheral 220 to the other one of the wireless networks, detected in operation 320, to which the peripheral 220 has yet to be connected in operation 350. After operation 350, operation 340 is performed again.

If it is determined that the search packet is received via the connected wireless network in operation 340, the wireless network determination unit 228 of the peripheral 220 determines the wireless network connected in operation 330 or 350 as the host-connected network in operation 360.

More specifically, when operation 330 is performed right before operation 340, the peripheral 220 determines the wireless network connected in operation 330 as the host-connected network. If operation 350 is performed right before operation 340, the peripheral 220 determines the wireless network connected in operation 350 as the host-connected network.

The present general inventive concept can be embodied as computer readable code in a computer readable medium to perform the above-described method. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system. Also, functional program, code, and code segments for accomplish the present invention can be easily derived by programmers in the art.

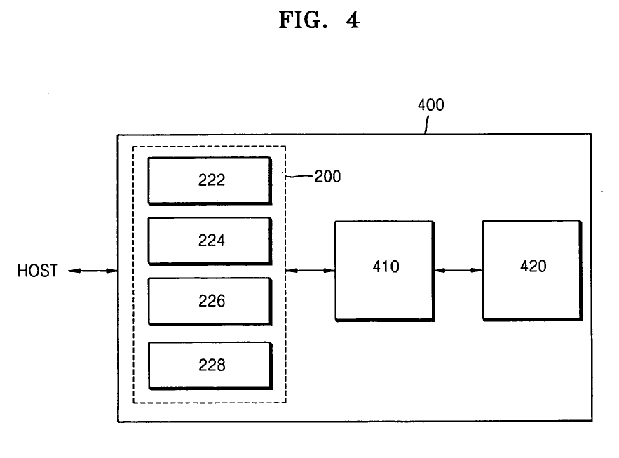

FIG. 4 is a view illustrating an image forming apparatus 400 to determine a wireless network with an external host according to an embodiment of the present general inventive concept. Referring to FIG. 4, the image forming apparatus 400 is an example of the peripheral 130 or 220 of FIG. 1 or 2, and includes a determination unit 200 which includes the wireless network detecting unit 222, the wireless network connecting unit 224, the checking unit 226, and the wireless network determination unit 228 as illustrated in FIG. 2, a printing unit 420 to print an image according to data received from the host 110 or 210, and a controller to control the determination unit 200 to establish a wireless link with the host 10 or 210 without manual settings thereof and to control the printing unit 420 to print the image according to data received through the established wireless link.

As described above, in a method and apparatus to determine a wireless network link according to the present embodiment, a peripheral supporting wireless networking detects one or more wireless networks to which it can be connected, connects itself to each of the detected wireless networks to determine whether data from a host is received via any of the connected wireless networks, and detects a host-connected network from the detected wireless networks, based on the determination result. Accordingly, the peripheral can detect a host-connected wireless network without changing settings of the host, thereby easily establishing a wireless connection between the peripheral and the host without a user's operation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of determining a wireless network link, the method comprising:
detecting one or more connectable wireless networks, and forming a link to one of the detected wireless networks;
determining whether predetermined data wirelessly transmitted from an external host is received via the linked wireless network; and
determining the linked wireless network as a host-connected network to which the external host is wirelessly connected, when the predetermined data is received via the linked wireless network.

2. The method of claim 1, further comprising:
forming a second link to the other one of the detected wireless networks when it is determined that the predetermined data is not received via the linked wireless network;
determining whether the predetermined data wirelessly transmitted from the external host is received via the second-linked wireless network; and
determining the second-linked wireless network as the host-connected network to which the external host is wirelessly connected, when the predetermined data is received via the second-linked wireless network.

3. The method of claim 1, wherein the detecting of one or more connectable wireless networks, the forming of the link, the determining of whether predetermined data wirelessly transmitted from the external host is received via the linked wireless network, and the determining of the linked wireless network as the host-connected network is performed in a peripheral to be wirelessly connected to the external host, and the peripheral is used to form an image under control of the host.

4. The method of claim 1, further comprising:
printing an image according to the received data from the external host through the determined host-connected wireless network.

5. The method of claim 1, further comprising:
transmitting the predetermined data in the external host for a first period of time,
wherein whether the predetermined data wirelessly transmitted from the external host is received via the linked wireless network is determined for a second period of time.

6. The method of claim 1, wherein the detecting of the one or more connectable wireless networks and the forming of the link to one of the detected wireless networks comprise connecting each of the detected wireless network to form the link.

7. The method of claim 1, wherein the determining of whether the predetermined data wirelessly transmitted from the external host is received via the linked wireless network comprises determining whether a search packet is received from the external host.

8. The method of claim 1, wherein the determining of whether the predetermined data wirelessly transmitted from the external host is received via the linked wireless network comprises determining whether a service set identifier is received from the external host.

9. A system to determine a wireless network link, the system comprising:
a host to transmit predetermined data via a predetermined wireless network; and
a peripheral to detect one or more wireless networks to which a predetermined link is to be formed with the host, to form a link to each of the detected wireless networks to determine whether the predetermined data is received via the linked wireless network, and to determine the linked wireless network as the predetermined wireless network when it is determined that the predetermined data is received via the linked wireless network.

10. An apparatus to determine a wireless network link, the apparatus comprising:
a peripheral to detect one or more wireless networks, to form a link to make a link with one of the detected wireless networks to determine whether the predetermined data is received via the linked wireless network, and to determine the linked wireless network as a predetermined wireless network when it is determined that the predetermined data is received via the linked wireless network.

11. The apparatus of claim 10, wherein the peripheral comprises:
a wireless network detecting unit to detect the one or more wireless networks to which the link is to be formed with the peripheral;
a wireless network connecting unit to form the link to one of the detected wireless networks;
a checking unit to check whether the predetermined data is received via the linked wireless network; and
a wireless network determination unit to determine the linked wireless network as the predetermined wireless network based on the checking result.

12. The apparatus of claim 10, wherein the peripheral comprises a printing unit to form an image according to the predetermined data received from a host.

13. The apparatus of claim 10, wherein the peripheral forms a second link to the other one of the detected wireless networks when it is determined that the predetermined data is not received via the linked wireless network, determines whether the predetermined data wirelessly transmitted from an external host is received via the second-linked wireless network, and determines the second-linked wireless network as the host-connected network to which the external host is wirelessly connected, when the predetermined data is received via the second-linked wireless network.

14. The apparatus of claim 10, wherein the peripheral makes links to the respective detected wireless networks to determine whether the predetermined data is received via the respective linked wireless networks.

15. The apparatus of claim 10, wherein the predetermined data comprises a search packet sent from an external host through the predetermined wireless network.

16. The apparatus of claim 10, wherein the predetermined data comprises a service set identifier.

17. A computer readable recording medium having embodied thereon a program which executes a method of determining a wireless network link, the method comprising:
detecting one or more connectable wireless networks, and forming a link to one of the detected wireless networks;
determining whether the predetermined data wirelessly transmitted from an external host is received via the linked wireless network; and
determining the linked wireless network as the host-connected network when the predetermined data is received via the linked wireless network.

18. The computer readable recording medium of claim 17, wherein the method further comprises:
forming a second link to the other one of the detected wireless networks when it is determined that the predetermined data is not received via the linked wireless network;
determining whether the predetermined data wirelessly transmitted from the external host is received via the second-linked wireless network; and
determining the second-linked wireless network as the host-connected network to which the external host is wirelessly connected, when the predetermined data is received via the second-linked wireless network.

19. The computer readable recording medium of claim 17, wherein the method further comprises printing an image according to the received data from the external host through the determined host-connected wireless network.

20. The computer readable recording medium of claim 17, wherein the method further comprises determining whether one or a search packet and a service set identifier wirelessly transmitted from the external host is received via the linked wireless network.
